(19) United States
(12) Patent Application Publication
(10) Pub. No.: US 2024/0248434 A1
(43) Pub. Date: Jul. 25, 2024

(54) TIMEPIECE COMPONENT MADE OF COLORED FORGED CARBON AND METHOD FOR MANUFACTURING SUCH A TIMEPIECE COMPONENT

(71) Applicant: MANUFACTURE D'HORLOGERIE AUDEMARS PIGUET SA, Le Brassus (CH)

(72) Inventors: Thibaut LE LOARER, Chavannaz (FR); Pedro SANCHEZ NOGUEIRA, Vigo (ES)

(21) Appl. No.: 18/559,695

(22) PCT Filed: Jun. 23, 2022
(86) PCT No.: PCT/EP2022/067213

§ 371 Date: Nov. 8, 2023

(30) Foreign Application Priority Data
Jun. 29, 2021 (CH) 00754/21

(51) Int. Cl. G04B 37/22; B29C 70/00; B29C 70/02; B29C 70/46; B29K 63/00; B29K 307/04; B29K 505/02; G04B 45/00

(52) U.S. Cl. CPC G04B 37/225; B29C 70/0035; B29C 70/025; B29C 70/46; G04B 45/0015; B29K 2063/00; B29K 2307/04; B29K 2505/02

(57) ABSTRACT

A horological component is disclosed, which comprises at least one portion made of colored forged carbon comprising cut carbon fibers, secured to one another by a matrix comprising at least one resin as component, and at least one pigment, the pigment taking the form of solid particles that cannot be mixed with, or are not soluble in, the resin or resins of which the matrix is composed, and the particles of pigment being situated on the surface of at least some of the carbon fibers and located in one or more predefined regions of the portion of horological component. A manufacturing method allowing such a horological component to be produced is also disclosed.

### CROSS-REFERENCE TO RELATED APPLICATIONS

This application is the US national stage of PCT/EP2022/067213, filed Jun. 23, 2022 and designating the United States, which claims the priority of CH 00754/21, filed Jun. 29, 2021. The entire contents of each foregoing application are incorporated herein by reference.

### TECHNICAL FIELD

The present invention relates to a horological component comprising at least one portion made of coloured forged carbon comprising cut carbon fibres, secured to one another by a matrix comprising at least one resin as component, and at least one pigment.

The present invention relates also to a method for manufacturing a block of coloured forged carbon for the production of a horological component.

Hereinafter in the present text, the expression “carbon fibre” will be used to designate a strand comprising a plurality of individual carbon filaments arranged against one another substantially in one and the same direction.

### STATE OF THE ART

Coloured composite materials based on fibre-reinforced resin are already known, notably in the horology field.

Two general approaches are typically implemented to produce such products.

According to a first approach, coloured glass fibres are used to reinforce a resin, possibly in combination with conventional black carbon fibres. An example of watch case produced according to this approach is presented here: https://www.lepoint.fr/montres/sihh-2019-girard-pe regaux-presente-le-carbon-glass-14-01-2019-2285643_2648.php.

According to a second approach, a pigment is dissolved in the resin used to produce the matrix of the composite compound. In this case, the manufacturer may not have control over the regions of the final product which will actually be coloured because of a possible migration of the portions of resin which contain the pigment. Nor also is it possible to produce, in a controlled manner, a composite block which would have at least two different colours because of the movements of the resin of which the matrix is composed, in particular during the pressurized temperature raising operation. Indeed, different coloured portions of the resin mix with one another during this operation, giving rise to at least one combined colour. Thus, the combined use of yellow pigments and of blue pigments would cause green regions to be obtained in the final product.

As an example, the patent application WO 2021/099433 A1 discloses a method for manufacturing composite materials of the type which has just been described. This patent application provides two variant embodiments of the manufacturing method concerned. In one case, carbon or aramid fibres are pre-impregnated with a coloured resin before being mixed with a matrix. In the other case, the matrix is coloured, but not necessarily the carbon or aramid fibres. In one case as in the other, the pigment used is dissolved in a resin and can consequently migrate as explained above.

Consequently, there is still a need to be able to produce a composite product made of coloured forged carbon of good quality and in which the coloured regions are controlled by the manufacturer, both in terms of their location and of their colour.

Moreover, it will also be noted that the forged carbon-based compounds currently known generally exhibit a high porosity causing brittleness, rendering them unsuitable for the production of certain horological components, notably horological components which could be subjected to impacts and/or horological components of small dimensions such as control push-pieces for example.

### DISCLOSURE OF THE INVENTION

One aim of the present invention is to propose an alternative to the composite products known from the prior art by proposing a horological component that has the mechanical qualities of forged carbon and an original colouring of which the parameters are predefined, therefore controlled, by the manufacturer, both to allow the latter to obtain the desired appearance and a certain level of reproducibility if necessary.

To this end, the present invention relates to a horological component of the type mentioned above, characterized by the fact that the pigment or pigments take the form of solid particles that cannot be mixed with, or are not soluble in, the resin or resins of which the matrix is composed, and by the fact that the particles of the pigment or pigments are situated on the surface of at least some carbon fibres and located in one or more predefined regions of the portion of the horological component.

By virtue of these features, the production of a horological component of predefined appearance is made possible, with coloured regions that are well defined in advance, unlike the known products, the composition of which necessarily results in a final random appearance. Furthermore, it is also possible, by virtue of such a composition, to produce a product that has a predefined number of colours, because the various particles of pigments cannot be mixed with, or are not soluble in, the matrix. Any mixing of colours is thus avoided, unlike the known products.

According to a preferred embodiment, provision can be made for the or at least one resin of the matrix to be of epoxy type.

Moreover, provision can be made for the matrix to have a crosslinked structure involving groups chosen from among the group comprising isocyanates, blocked isocyanates, anhydrides, thiols, phenols, amines and amides.

Preferably, provision can be made for the carbon fibres to have a dry basis weight of between 50 and 900 g·m−2, more preferably between 150 and 600 g·m−2.

Provision can also advantageously be made for the carbon fibres to have a width of between 1 and 15 mm, preferably between 1 and 5 mm, and, possibly, for them to have a Young's modulus greater than 45 GPa (according to the ASTM D3039 standard), preferably greater than 50 GPa.

It is also possible to provide for the carbon fibres to be grouped together in the form of strands comprising between 1 500 and 50 000 filaments.

Moreover, provision can be made for the particles of pigment(s) to have dimensions of between 20 and 100 μm, preferably between 20 and 80 μm.

Generally, the pigments can preferably be chosen from the group comprising aluminium oxides, silicon dioxides, micas or the mixtures thereof.

Generally, provision can advantageously be made for the horological component to be a cladding element for a timepiece, preferably a middle, a bezel, a bottom, an external control member, in particular a crown or a push-piece, or a wristlet element. Obviously, the horological component will also be able to be a horological movement component, without in any way departing from the scope of the invention as defined by the attached claims.

The present invention relates also to a method for manufacturing a block made of coloured forged carbon, for the production of a horological component, comprising the steps of:
a) obtaining cut carbon fibres, impregnated with a first resin, on the surface of which are arranged solid particles of at least one pigment that cannot be mixed with, or is not soluble in, the first resin,
b) arranging the cut carbon fibres in a mould, preferably with a matrix comprising the first resin and/or a second resin, of the same chemical nature as the first resin, and a crosslinking agent,
c) closing the mould and applying a negative pressure thereto, and
d) applying a pressure-raising and temperature-raising cycle suitable for producing a densification and a crosslinking of the mixture formed in the step b).

Advantageously, provision can be made for the first resin or the first and second resins to have a viscosity greater than 3000 mPa·s.

Furthermore, it is also possible to provide for the mixture comprising the first resin or the first and second resins and the crosslinking agent to have a viscosity greater than 350 mPa·s.

Preferably, provision can be made for the matrix to have a glass transition temperature (Tg) of between 150 and 220° C.

Moreover, provision can advantageously be made for the matrix to have a proportion of resin of between 70 and 90% by weight, preferably between 75 and 85%.

It is also possible to provide for the mixture formed in the step b) to have a proportion of carbon fibres of between 50 and 80% by weight, preferably between 60 and 75%.

As an alternative or in addition, provision can be made for the mixture formed in the step b) to have a proportion of pigment(s) of between 0.5 and 10% by weight, preferably between 1 and 5%.

Moreover, provision can advantageously be made for the step d) to include the application of at least three different temperature levels, preferably at least four, more preferably at least five.

Generally, provision can be made for the method according to the invention to comprise at least one additional step of machining of the block obtained after the implementation of the steps a) to d).

### BRIEF DESCRIPTION OF THE DRAWINGS

Other features and advantages of the present invention will emerge more clearly on reading the following detailed description of a preferred embodiment, given with reference to the attached drawings which are given by way of nonlimiting examples, and in which:

FIGS. 1a and 1b represent simplified diagrams illustrating a step of implementation of a preferred embodiment of the method according to the invention, according to two different variant embodiments.

FIG. 2 represents a photo of a block obtained according to the invention and having several distinct colours.

### EMBODIMENT(S) OF THE INVENTION

The present invention relates to a horological component comprising at least one portion made of coloured forged carbon comprising cut carbon fibres, secured to one another by a matrix comprising at least one resin as component, and at least one pigment. More specifically, the horological component according to the invention has a structure such that the pigment takes the form of solid particles that cannot be mixed with, or are not soluble in, the resin or resins of which the matrix is composed, and that the particles of the pigment or pigments are situated on the surface of at least some of the carbon fibres and located in one or more predefined regions of the relevant portion of the horological component.

Preferred features of the horological component according to the present invention, and a preferred manufacturing method based on moulding of a block of forged carbon, preferably of relatively low porosity to allow the production of such a horological component of high quality, will now be explained hereinbelow.

Generally, different approaches are possible in the context of the present invention with respect to the moulding method. The mould used can have any form allowing the production of a block which will then be machined to finalize a predefined portion of horological component or a predefined entire horological component. As an alternative, it is possible to use a mould corresponding to the general form of the portion of the horological component or of the horological component but in greater dimensions (“near shape”), the product of the moulding then typically being called “dégros” (“rough”) in the horological field.

While the use of a mould that has directly the exact dimensions of the part to be obtained is not totally excluded in the context of the present invention, it is not preferred for the following reasons: on the one hand, it can be difficult to obtain a good distribution between the carbon fibres and the matrix in sharp corners and/or recesses of the mould, if appropriate, and, on the other hand, the part obtained after the moulding step generally has a greater proportion of matrix on the surface, because the latter undergoes a creep phenomenon during the curing. In the latter case, the part obtained by moulding may have a bright plastic material appearance which is not only not necessarily suited to the production of high-end horological components, but which implies a resistance to impacts and scratches lower than that of a portion of material in which the proportion between the matrix and the carbon fibres would be more balanced.

As will be understood from the above, the manufacturing of a horological component according to the invention involves the use of cut carbon fibres, that is to say carbon filaments grouped together in the form of strands of cut filaments, these strands being called here carbon fibres, of at least one resin, in particular to define a matrix, and of solid particles of at least one pigment that cannot be mixed with, or is not soluble in, the matrix.

Generally, the method for manufacturing a block made of coloured forged carbon, for the production of a horological component according to the present invention, advantageously comprises the steps of:
a) obtaining cut carbon fibres, impregnated with a first resin, on the surface of which are arranged solid particles of at least one pigment that cannot be mixed with, or is not soluble in, the first resin,
b) arranging the cut carbon fibres in a mould, preferably with a matrix comprising the first resin and/or a second resin, of the same chemical nature as the first resin, and a crosslinking agent,
c) closing the mould and applying a negative pressure thereto, and
d) applying a pressure-raising and temperature-raising cycle suitable for producing a densification and a crosslinking of the mixture formed in the step b).

The carbon fibres used in the context of the implementation of the present invention are preferably unidirectional carbon fibres pre-impregnated with the first resin, that is to say that a certain quantity of the first resin is applied to the carbon fibres so that the latter exhibit a non-zero adhesive power at ambient temperature. Solid particles of one or more pigments can then be mixed with the pre-impregnated carbon fibres and adhere to the surface thereof.

Such a step of pigmentation of the pre-impregnated carbon fibres can be implemented without preference before or after the carbon fibres are cut.

The particles of pigment(s) can be intermingled with the pre-impregnated carbon fibres randomly or in a predefined controlled manner.

Preferably, the carbon fibres can have a dry basis weight (without being impregnated) of the order of 50 to 900 g/m2, more preferably between 150 and 600 g/m2, and each of them can comprise a number of filaments of the order of 1 500 to 50 000. Moreover, the carbon fibres can advantageously have a width of between 1 and 15 mm, more preferably between 1 and 5 mm, and have a Young's modulus greater than 45 GPa, more preferably greater than 50 GPa (measured according to the ASTM D3039 standard).

As mentioned above, one and the same resin can be used, on the one hand, to pre-impregnate the carbon fibres and, on the other hand, to form the matrix. Alternatively, the second resin used to form the matrix can be different from the first resin used to pre-impregnate the carbon fibres. In this case, the two resins should have the same chemical nature.

Hereinbelow, the term resin or a resin will be used generally, it being understood that the preferred characteristics which will be set out will apply to both resins if necessary.

Preferably, the resin used in the context of the implementation of the present invention is preferably of epoxy type and will advantageously be able to be of neutral colour so as not to intervene in the final colouring of the block finally obtained. The resin advantageously has a relatively low viscosity and a good wettability to be able to disperse uniformly and make it possible to eliminate possible air zones which would create regions of excessive porosity on the block finally obtained. Thus, the viscosity of the resin will preferably be greater than 3000 mPa·s.

Conventionally, the matrix also comprises a crosslinking agent or hardening agent (or “crosslinker”) which will preferably be able to be chosen from the group comprising isocyanates, blocked isocyanates, anhydrides, thiols, phenols, amines and amides.

Preferably, the matrix contains between 70 and 90%, more preferably between 75 and 85%, by weight of resin.

The mixture comprising the resin and the crosslinking agent will preferably be able to be produced in such a way that its viscosity is greater than 350 mPa·s, and in such a way that the glass transition temperature Tg of the matrix is between 150 and 220° C.

Regarding the pigment or pigments used, they are preferably intrinsically not miscible with, or not soluble in, the matrix so as not to migrate in the curing step and remain on the surface of the carbon fibres on which they have been deposited. In the case where several different pigments are used simultaneously, that notably makes it possible to avoid them mixing with one another.

The pigment or pigments can preferably be chosen from the group comprising aluminium oxides, silicon dioxides, micas and mixtures thereof. The size of the pigments, D-50, is preferably between 20 and 100 μm, more preferably less than 80 μm.

The mixture formed in the step b) above preferably has a proportion of carbon fibres of between 50 and 80% by weight, preferably between 60 and 75%.

Moreover, this mixture preferably has a proportion of pigment(s) of between 0.5 and 10% by weight, preferably between 1 and 5%.

Once the pre-impregnated and coloured cut carbon fibres are arranged in a suitable mould, with a possible complement of resin to finalize the matrix, a vacuumizing, for example the application of a pressure lower than atmospheric pressure by at least 30 mbar, for example 900 mbar, then a suitable pressure-raising—for example 4 bar then 10 bar—and temperature-raising cycle to produce a densification and a crosslinking of the mixture is applied, as mentioned in the step d) above.

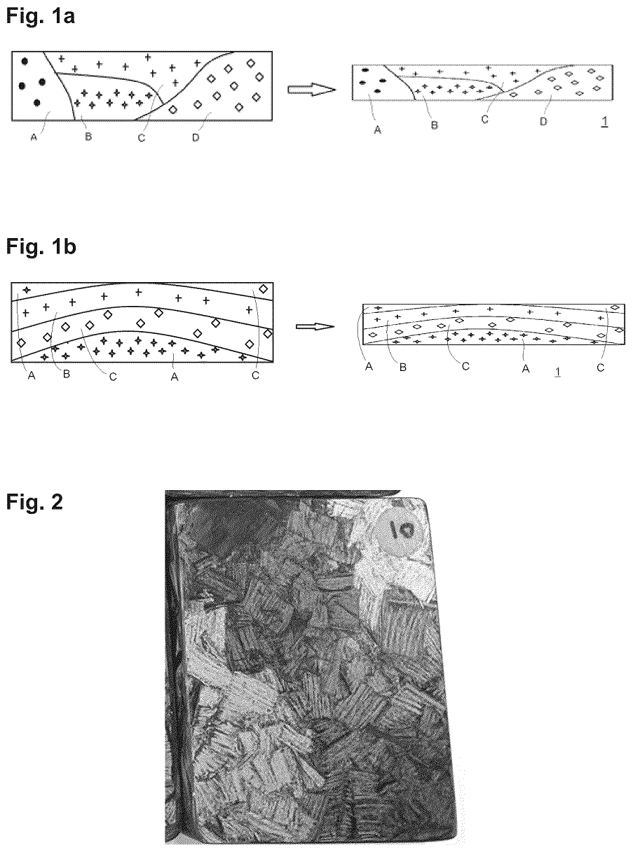

FIGS. 1a and 1b schematically illustrate two different general approaches for the placement of the carbon fibres in a mould, leading to two different results for the block 1 finally obtained.

FIG. 1a schematically illustrates, on the left, a random arrangement of carbon fibres in a mould (not represented), four groups of carbon fibres being used, fibres A not coloured, fibres B coloured with a first pigment, fibres C coloured with a second pigment, different from the first pigment, and fibres D coloured with a third pigment, different from the first two pigments. The block 1 obtained after curing is schematically illustrated on the right of FIG. 1a. The block 1 finally has a random distribution of the different carbon fibres corresponding to their distribution in the mould before the curing cycle. The particles of pigments have remained on the surface of the carbon fibres that they covered before the curing cycle and no mixing of the corresponding colours is observed. Thus, for example, in the case where yellow, red and blue pigments are used, no formation of regions of violet, orange or green colouring is observed in the block 1 finally obtained. It is also observed that the block 1 exhibits a colouring in mass since, in particular, the coloured carbon fibres which had been arranged in the centre of the mixture in the mould before the curing cycle are still situated at the centre of the block 1 finally obtained.

Similarly, FIG. 1b schematically illustrates, on the left, an arrangement of carbon fibres in a mould (not represented) in the form of superposed layers, the carbon fibres being distributed in three groups, in an illustrative nonlimiting manner, fibres A not coloured, fibres B coloured with a first pigment and fibres C coloured with a second pigment, different from the first pigment. The block 1 obtained after curing is illustrated schematically on the right in FIG. 1b. The block 1 finally has a distribution of the different carbon fibres A, B and C in the form of layers corresponding to the layers deposited in the mould before the curing cycle.

Thus, it emerges that the appearance of the block finally obtained after the curing cycle is predictable, even controllable, and it is possible to produce a horological component from the block 1 which has a predefined distribution of coloured carbon fibres.

An example of curing cycle, to obtain the preferred properties, namely a porosity of less than 5%, more preferably less than 3%, even more preferably less than 1%, and a very good mechanical strength, notably to impacts, can be:

| | | | | | | | | |
|---|---|---|---|---|---|---|---|---|
| Duration | startup | 15 min | 8 h | 3 h | 3 h | 2 h | 1 h | 3 h |
| Temper- | Tamb | Tamb | 50 | 90 | 120 | 150 | 200 | Tamb |
| ature | | | | | | | | |
| (° C.) | | | | | | | | |
| Pressure | Patm | Patm- | 4 | 10 | 10 | 8 | 2 | Patm |
| | | 70 mbar | bar | bar | bar | bar | bar | |

(Tamb = ambient temperature; Patm = atmospheric pressure)

Generally, it will preferably be possible to prioritize the implementation of at least two levels of different temperatures, more preferably of at least three levels, to improve the quality of the block finally obtained in terms of porosity and mechanical strength.

FIG. 2 represents a photo of an example of block obtained after the curing cycle containing different regions of different respective colours. The block visible in FIG. 2 was produced, as a nonlimiting example, by arranging coloured carbon fibres in the mould, grouping together fibres of the same colour by regions. Adjacent regions of different colours are thus obtained, without mixing between the colours used.

As mentioned previously, the block finally obtained after the curing cycle can be machined, if necessary, to produce the desired portion of the horological component or the entire horological component depending on the particular case. The machining will be able to be done by any known suitable method, notably by laser or by CNC machine.

Using the method which has just been described, it is possible to produce a horological component that exhibits high-level mechanical properties, in particular in terms of resistance to impacts and to scratches, while having an attractive look because of an original appearance, in particular having regions of different colours distributed according to a predefined pattern.

Thus, using the method according to the present invention, a manufacturer of horological components will be able to offer a robust and attractive horological component, whether it is intended to be incorporated in a horological movement or whether it is intended for the production of a cladding element for a timepiece, preferably a middle, a bezel, a bottom, an external control member, in particular a crown or a push-piece, or a wristlet element.

The description above sets out to describe a preferred embodiment in an illustrative and nonlimiting manner, and the person skilled in the art will have no particular difficulty in adapting the content of the present disclosure to his or her own requirements without departing from the scope of the present invention as defined by the attached claims, being it noted that any combination of any features contained in the claims should be considered as included within the scope of the invention as long as it has a technical meaning.

1. A horological component comprising at least one portion made of coloured forged carbon comprising cut carbon fibres, secured to one another by a matrix comprising one or several resins as component, and at least one pigment,
wherein said at least one pigment takes the form of solid particles that cannot be mixed with, or are not soluble in, the resin or resins of which said matrix is composed, and
wherein said particles of said at least one pigment are situated on the surface of at least some of said cut carbon fibers and located in one or more predefined regions of said at least one portion.

2. The horological component of claim 1, further comprising at least one additional pigment taking the form of solid particles that cannot be mixed with, or are not soluble in, the resin or resins of which said matrix is composed, and
wherein said particles of said at least one additional pigment are situated on the surface of at least some of said cut carbon fibers and located in one or more additional predefined regions of said at least one portion distinct from said one or more predefined regions.

3. The horological component of claim 1, wherein said one resin or at least one of said several resins of said matrix is of epoxy type.

4. The horological component of claim 1, wherein said matrix has a crosslinked structure involving groups chosen from among the group comprising isocyanates, blocked isocyanates, anhydrides, thiols, phenols, amines and amides.

5. The horological component of claim 1, wherein said cut carbon fibers have a dry basis weight of between 50 and 900 g·m−2.

6. The horological component of claim 1, wherein said cut carbon fibers have a width of between 1 and 15 mm.

7. The horological component of claim 1, wherein said cut carbon fibres have a Young's modulus greater than 45 GPa (according to the ASTM D3039 standard).

8. The horological component of claim 1, wherein said cut carbon fibers are grouped together in the form of strands comprising between 1 500 and 50 000 filaments.

9. The horological component of claim 1, wherein said particles of said at least one pigment(s) have dimensions of between 20 and 100 μm.

10. The horological component of claim 1, wherein said at least one pigment is chosen from the group comprising aluminum oxides, silicon dioxides, micas or mixtures thereof.

11. The horological component of claim 1, wherein the component is a cladding element for a timepiece.

12. A method for manufacturing a block made of colored forged carbon, for the production of a horological component, comprising the steps of:
a) obtaining cut carbon fibers, impregnated with a first resin, on the surface of which are arranged solid particles of at least one pigment that cannot be mixed with, or is not soluble in, said first resin,
b) arranging said cut carbon fibers in a mold, with a matrix comprising said first resin and/or a second resin, of the same chemical nature as said first resin, and a crosslinking agent,
c) closing the mold and applying a negative pressure thereto, and
d) applying a pressure-raising and temperature-raising cycle suitable for producing a densification and a crosslinking of the mixture formed in the step b).

13. The method of claim 12, wherein said first resin or said first resin and second resin are of epoxy type.

14. The method of claim 12, wherein said first resin or said first resin and second resin have a viscosity greater than 3000 mPa·s.

15. The method of claim 12, wherein said crosslinking agent is chosen from the group comprising isocyanates, blocked isocyanates, anhydrides, thiols, phenols, amines and amides.

16. The method of claim 12, wherein the mixture comprising said first resin or said first resin and second resin and the crosslinking agent has a viscosity greater than 350 mPa·s.

17. The method of claim 12, wherein said matrix has a glass transition temperature (Tg) of between 150 and 220° C.

18. The method of claim 12, wherein said matrix has a proportion of resin of between 70 and 90% by weight.

19. The method of claim 12, wherein said mixture formed in the step b) has a proportion of cut carbon fibers of between 50 and 80% by weight.

20. The method of claim 12, wherein said mixture formed in the step b) has a proportion of pigment of between 0.5 and 10% by weight.

21. The method of claim 12, wherein said particles of said at least one pigment(s) have dimensions of between 20 and 100 μm.

22. The method of claim 12, wherein said at least one pigment is chosen from the group comprising aluminum oxides, silicon dioxides, micas or mixtures thereof.

23. The method of claim 12, wherein step d) comprises the application of at least three different temperature levels.

24. The method of claim 12, further comprising at least one additional step of machining of said block (1) obtained after the implementation of the steps a) to d).

25. The horological component of claim 2, wherein said one resin or at least one of said several resins of said matrix is of epoxy type.

26. The horological component of claim 2, wherein said matrix has a crosslinked structure involving groups chosen from among the group comprising isocyanates, blocked isocyanates, anhydrides, thiols, phenols, amines and amides.

27. The horological component of claim 2, wherein said cut carbon fibers have a dry basis weight of between 50 and 900 g·m−2.

28. The horological component of claim 2, wherein said cut carbon fibers have a width of between 1 and 15 mm.

29. The horological component of claim 2, wherein said cut carbon fibers have a Young's modulus greater than 45 GPa (according to the ASTM D3039 standard.

30. The horological component of claim 2, wherein said cut carbon fibers are grouped together in the form of strands comprising between 1 500 and 50 000 filaments.

31. The horological component of claim 2, wherein said particles of said at least one pigment and of said at least one additional pigment have dimensions of between 20 and 100 μm.

32. The horological component of claim 2, wherein said at least one pigment and said at least one additional pigment are chosen from the group comprising aluminum oxides, silicon dioxides, micas or mixtures thereof.

33. The method of claim 13, wherein said first resin or said first resin and second resin have a viscosity greater than 3000 mPa·s.

34. The method of claim 13, wherein said mixture formed in the step b) has a proportion of pigment of between 0.5 and 10% by weight.

35. The method of claim 13, wherein said particles of said at least one pigment have dimensions of between 20 and 100 μm.

36. The method of claim 13, wherein said at least one pigment is chosen from the group comprising aluminum oxides, silicon dioxides, micas or mixtures thereof.

37. The method of claim 13, wherein step d) comprises the application of at least three different temperature levels.

38. The method of claim 13, further comprising at least one additional step of machining of said block (1) obtained after the implementation of the steps a) to d).
